(19) United States
(12) Patent Application Publication
(10) Pub. No.: US 2017/0047085 A1
(43) Pub. Date: Feb. 16, 2017

(54) MAGNETORESISTIVE ELEMENT

(71) Applicant: KABUSHIKI KAISHA TOSHIBA, Tokyo (JP)

(72) Inventor: Kenji NOMA, Yokkaichi Mie (JP)

(73) Assignee: KABUSHIKI KAISHA TOSHIBA, Tokyo (JP)

(21) Appl. No.: 15/061,850

(22) Filed: Mar. 4, 2016

Related U.S. Application Data
(60) Provisional application No. 62/204,240, filed on Aug. 12, 2015.

(51) Int. Cl. G11B 5/39

(52) U.S. Cl. CPC G11B 5/3903

(57) ABSTRACT

According to one embodiment, a magnetoresistive element includes a first magnetic layer having an invariable magnetization direction, a second magnetic layer having a variable magnetization direction, a first nonmagnetic layer between the first and second magnetic layers, a third magnetic layer having a variable magnetization direction, the magnetization directions of the second and third magnetic layers being opposite directions each other, and a second nonmagnetic layer between the second and third magnetic layers.

### CROSS-REFERENCE TO RELATED APPLICATIONS

This application claims the benefit of U.S. Provisional Application No. 62/204,240, filed Aug. 12, 2015, the entire contents of which are incorporated herein by reference.

### FIELD

Embodiments described herein relate generally to a magnetoresistive element.

### BACKGROUND

A magnetoresistive element includes a reference layer having invariable magnetization, a storage layer having variable magnetization, and a nonmagnetic layer provided therebetween as its basic structure. Here, a hysteresis curve (magnetization reversal characteristic) of the storage layer of the magnetoresistive element shifts due to a stray magnetic field applied from the reference layer to the storage layer. This shift causes a read error and a write error.

A technique of providing a shift canceling layer having a magnetization direction opposite to that of the reference layer to eliminate such a shift of the hysteresis curve is known. However, in this technique, a sufficiently thick shift canceling layer is necessary to cancel a stray magnetic field from the reference layer. Therefore, there have been problems in that it is difficult to pattern the magnetoresistive element, and the shift cancellation effect varies with the variation in the shape of the magnetoresistive element.

### BRIEF DESCRIPTION OF THE DRAWINGS

FIG. 1A and FIG. 1B are cross-sectional views showing a magnetoresistive element according to a first embodiment.

FIG. 2 is a diagram showing hysteresis curves.

FIG. 3 is a diagram showing an example of “1”-write operation.

FIG. 4 is a diagram showing an example of “0”-write operation.

FIG. 5A and FIG. 5B are cross-sectional views showing a magnetoresistive element according to a second embodiment.

FIG. 6 is a cross-sectional view showing a memory cell as an application example.

FIG. 7 is a diagram showing a memory system as an application example.

### DETAILED DESCRIPTION

In general, according to one embodiment, a magnetoresistive element comprises: a first magnetic layer having an invariable magnetization direction; a second magnetic layer having a variable magnetization direction; a first nonmagnetic layer between the first and second magnetic layers; a third magnetic layer having a variable magnetization direction, the magnetization directions of the second and third magnetic layers being opposite directions each other; and a second nonmagnetic layer between the second and third magnetic layers.

### First Embodiment

Structure

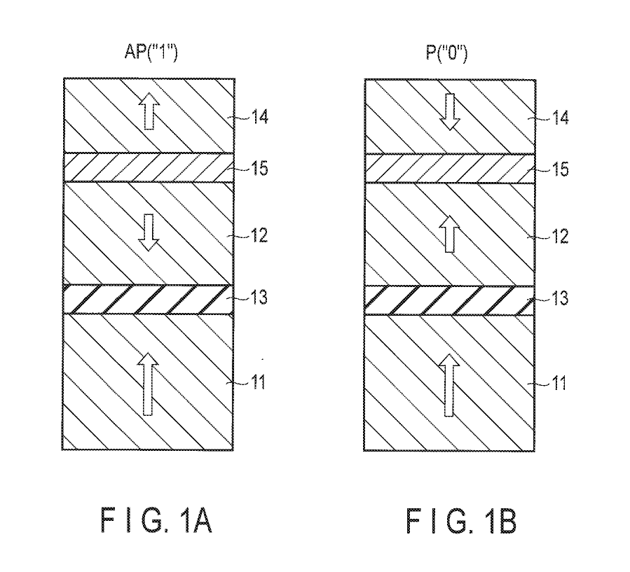

FIG. 1A and FIG. 1B show a magnetoresistive element according to a first embodiment.

The first embodiment relates to a technique of making small or cancelling a shift of a hysteresis curve (magnetization reversal characteristic) of a storage layer of the magnetoresistive element.

A first magnetic layer 11 is, for example, a magnetic layer (reference layer) having perpendicular and invariable magnetization. A second magnetic layer 12 is, for example, a magnetic layer (storage layer) having perpendicular and variable magnetization. A first nonmagnetic layer 13 is, for example, an insulating layer (tunnel barrier layer) between the first and second magnetic layers 11 and 12.

A third magnetic layer 14 is, for example, a magnetic layer (storage layer) having perpendicular and variable magnetization. A second nonmagnetic layer 15 is, for example, an electrically conductive layer between the second and third magnetic layers.

In the first, second, and third magnetic layers 11, 12, and 14, the perpendicular magnetization means magnetization in a direction in which the layers are stacked. In other words, the perpendicular magnetization means magnetization in a direction perpendicular to a film surface. A film surface means a boundary surface between the first magnetic layer 11, the first nonmagnetic layer 13, the second magnetic layer 12, the second nonmagnetic layer 15, and the third magnetic layer 14.

It should be noted that the first, second, and third magnetic layers 11, 12 and 14 may have in-plane magnetization. The in-plane magnetization means magnetization in a direction parallel to the film surface.

In addition, the invariable magnetization means that the magnetization direction does not vary before or after writing, and the variable magnetization means that the magnetization direction can vary before or after writing. The writing means spin transfer writing in which a spin implantation current (spin-polarized electrons) is made to flow through the rnagnetoresistive element, whereby a spin torque is imparted to the magnetization of the storage layer.

The second nonmagnetic layer 15 functions as a magnetic coupling layer which makes the magnetization directions of the second and third magnetic layers 12 and 14 is opposite directions each other. Therefore, the second and third magnetic layers 12 and 14 have characteristics in that the magnetization of the second magnetic layer 12 and the magnetization of the third magnetic layer 14 are capable of being reversed in a state of being held antiparallel.

Here, the state of the magnetoresistive element is defined as follows.

For example, a state in which the magnetization direction of the first magnetic layer 11 as a reference layer and the magnetization direction of the second magnetic layer 12 as a storage layer are opposite as shown in FIG. 1A is defined as an antiparallel state (“1”-state) in which the magnetoresistive element is in a high-resistance state. In addition, a state in which the magnetization direction of the first magnetic layer as a reference layer and the magnetization direction of the second magnetic layer 12 as a storage layer are the same as shown in FIG. 1B is defined as a parallel state (“0”-state) in which the magnetoresistive element is in a low-resistance state. However, this is merely an example.

According to the above-described structure, due to a stray magnetic field from the first magnetic layer 11 as a reference layer, the hysteresis curve of the storage layer shifts in the positive direction in which “1”-write (write which switches the magnetoresistive element from the “0”-state to the “1”-state) becomes difficult. However, in the present embodiment, the storage layer has a synthetic antiferromagnetic structure (SAF structure).

If the SAF structure is adopted in the storage layer, the “1”-write becomes easy as compared to that in the case where it is not adopted. As a result, the shift in the positive direction of the hysteresis curve of the storage layer of the magnetoresistive element can be made small or cancelled. This will be described later in detail.

This effect is based on the fact that in the “1”-write, the third magnetic layer 14 exhibits the function of assisting the “1”-write. This means that the magnetic properties of the third magnetic layer 14 influence the shift of the hysteresis curve of the storage layer of the magnetoresistive element.

For example, if the effect of assisting the write is too large, a shift in the opposite negative direction, which exceeds the shift in the positive direction due to a stray magnetic field from the reference layer, occurs.

Therefore, in the present embodiment, it is important to control the magnetic properties of the third magnetic layer 14, and set the assist effect of facilitating the “1”-write by the third magnetic layer 14 to such an extent that it cancels exactly a shift due to a stray magnetic field from the reference layer.

Thus, in the present embodiment, for example, it is preferable to make the total magnetic moment of the third magnetic layer 14 less than or equal to the total magnetic moment of the second magnetic layer 12. This is because, by doing so, the assist effect of facilitating the “1”-write by the third magnetic layer 14 can be set to such an extent that it cancels exactly a shift due to a stray magnetic field from the reference layer.

It should be noted that the total magnetic moment means a composition of a spin magnetic moment peculiar to electrons having spins in magnetic elements in each magnetic layer and an orbital magnetic moment produced by the motion of all electrons.

Here, the total magnetic moments of the second and third magnetic layers 12 and 14 depend on a product of their saturation magnetizations and thicknesses. That is, in order to make the total magnetic moment of the third magnetic layer 14 less than that of the second magnetic layer 12 when the saturation magnetizations of the second magnetic layer 12 and the third magnetic layer 14 are equal, it is sufficient to make the third magnetic layer 14 thinner than the second magnetic layer 12.

Material Example

A material example of the magnetoresistive element of FIG. 1 will be described.

The first and second magnetic layers 11 and 12 comprise, for example, CoFeB, MgFeO, FeB, or a stacked structure of these materials. In the case of a magnetoresistive element having perpendicular magnetization, the first and second magnetic layers 11 and 12 preferably comprise TbCoFe having perpendicular magnetic anisotropy, an artificial lattice in which Co and Pt are stacked, L1o-ordered FePt, etc. In this case, CoFeB or FeB as an interfacial layer may be provided between the first magnetic layer 11 and the first nonmagnetic layer 13, and between the second magnetic layer 12 and the first nonmagnetic layer 13.

For example, it is preferable that a magnetic layer as the storage layer among the first and second magnetic layers 11 and 12 includes CoFeB or FeB, and a magnetic layer as the reference layer among the first and second magnetic layers 11 and 12 includes CoPt, CoNi, or CoPd.

The first nonmagnetic layer 13 comprises, for example, MgO or AlO. The first nonmagnetic layer 13 may be a nitride of Al, Si, Be, Mg, Ca, Sr, Ba, Sc, Y, La, Zr, Hf, etc. The first nonmagnetic layer 13 preferably has a thickness less than or equal to 1 nm to function as a tunnel barrier layer.

The third magnetic layer 14 comprises, for example, FePt, CoPt, CoCr, TbCo, or SmCo.

When the second magnetic layer 12 includes CoFeB and the third magnetic layer 14 includes FePt, the saturation magnetization of the third magnetic layer 14 is less than that of the second magnetic layer 12.

Therefore, even if the thicknesses of the second and third magnetic layers 12 and 14 are equalized, the total magnetic moment of the third magnetic layer 14 can be made less than that of the second magnetic layer 12.

In addition, the total magnetic moments of the second and third magnetic layers 12 and 14 may be equalized by making the third magnetic layer 14 thicker than the second magnetic layer 12.

When the second magnetic layer 12 includes CoFeB and the third magnetic layer 14 includes one of CoPt, CoCr, TbCo, and SmCo, the saturation magnetization of the third magnetic layer 14 is greater than that of the second magnetic layer 12.

In this case, the total magnetic moment of the third magnetic layer 14 can be made less than or equal to that of the second magnetic layer 12 by making the third magnetic layer 14 thinner than the second magnetic layer 12.

The second nonmagnetic layer 15 comprises, for example, one of Ru, Ir, Rh, Cr, V, Mo, Re, and Os. The second nonmagnetic layer 15 has an appropriate material and thickness according to the materials of the second and third magnetic layers 12 and 14. The second nonmagnetic layer 15 preferably has a thickness within a range of 0.4 to 1.2 nm to magnetically couple the second magnetic layer 12 and the third magnetic layer 14.

(Effect of Making Shift Small)

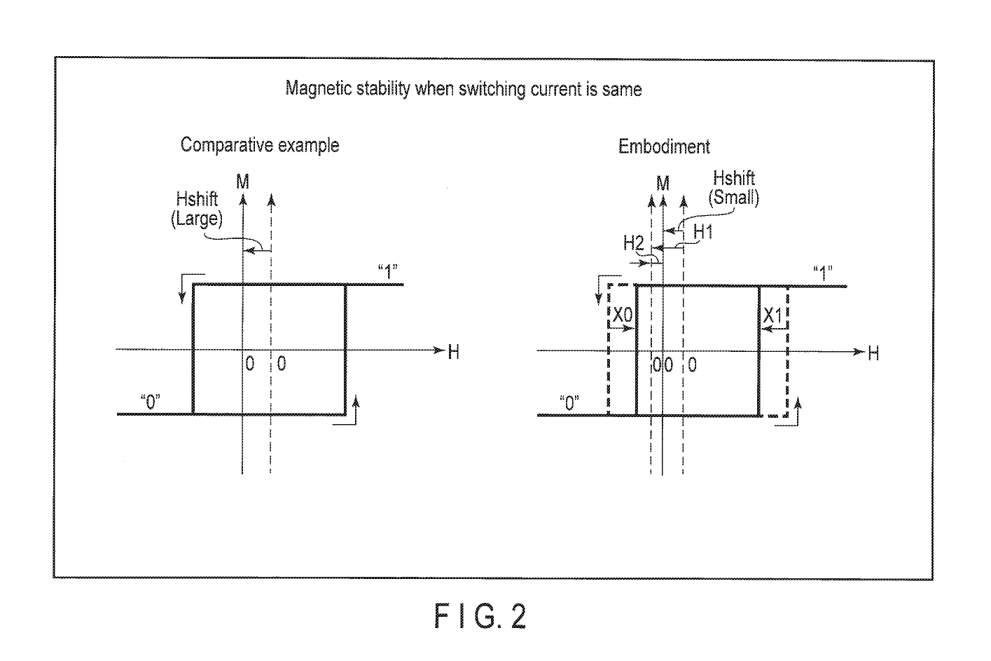

FIG. 2 shows hysteresis curves.

The hysteresis curve of the embodiment represents the magnetization reversal characteristic of the storage layer in the structure of FIG. 1A and FIG. 1B. The hysteresis curve of a comparative example represents the magnetization reversal characteristic of the storage layer in the case where the second nonmagnetic layer 15 and the third magnetic layer 14 are removed from the structure of FIG. 1A and FIG. 1B.

The horizontal axis of each of the hysteresis curves represents the current (corresponding to the magnetic field) H flowing through the magnetoresistive element, and the vertical axis represents the magnetization M of the storage layer of the magnetoresistive element.

In the comparative example, if a stray magnetic field from the reference layer is presumed to be zero, the hysteresis curve is bilaterally symmetrical (dotted vertical axis) with respect to a point at which the current H is zero (dotted vertical axis). However, in fact, because a stray magnetic field from the reference layer is applied to the storage layer, the hysteresis curve shifts in the positive direction (right direction) in which the “0”-state easily arises and the “1”-state hardly arises.

To cancel this shift H_{shift}, a shift canceling layer is provided. However, as memory cells are miniaturized, a sufficiently thick shift canceling layer becomes necessary to cancel the shift H_{shift}. In other words, if the shift canceling layer cannot be sufficiently thickened because of a problem in the manufacturing process, it becomes difficult to adjust a shift by the shift canceling layer. If it becomes difficult to adjust a shift by the shift canceling layer, a read error and a write error become likely.

On the other hand, in the embodiment, this shift H_{shift} of the hysteresis curve can be made small or cancelled. A stray magnetic field applied from the reference layer to the storage layer can be thereby cancelled, for example, by a thin shift canceling layer or without a shift canceling layer. That is, a shift of the hysteresis curve due to a stray magnetic field from the reference layer is eliminated, and thus, a read error and a write error can be prevented.

This will be described in detail.

Also in the embodiment, as in the comparative example, if a stray magnetic field from the reference layer is presumed to be zero, the hysteresis curve is bilaterally symmetrical with respect to a point at which the current H is zero (dotted vertical axis). However, in fact, because a stray magnetic field from the reference layer is applied to the storage layer, the hysteresis curve shifts in the positive direction (right direction) in which the “0”-state easily arises and the “1”-state hardly arises.

However, in the embodiment, this shift H_{shift} can be made smaller than in the comparative example.

This is the effect of the third magnetic layer 14, which antiferromagnetically couples with the second magnetic layer 12.

For example, in consideration of a stray magnetic field from the reference layer, the hysteresis curve of the storage layer shifts in the positive direction (right direction) by a shift H1 as in the comparative example.

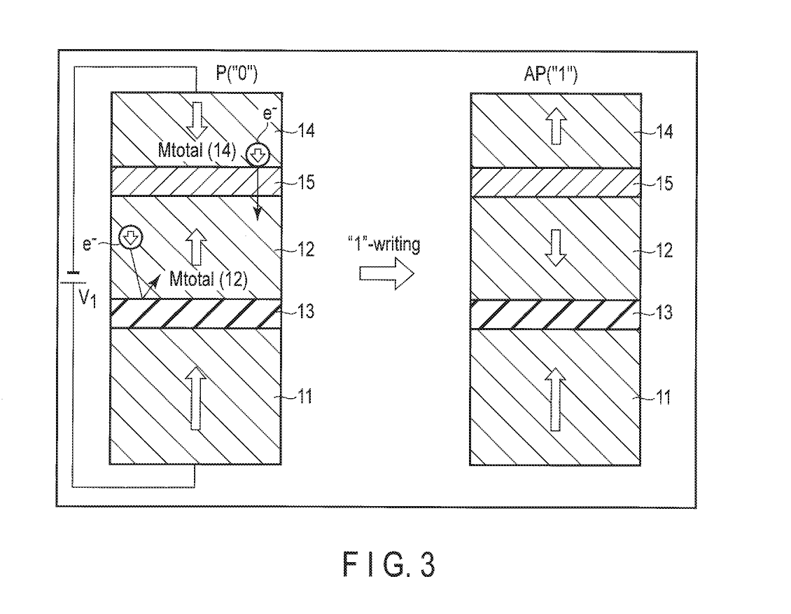

However, as shown in FIG. 3, when a positive potential V₁ is applied to the first magnetic layer 11 and a voltage of zero is applied to the third magnetic layer 14 in the “1”-write, a write current flows from the first magnetic layer 11 to the third magnetic layer 14. At this time, an electron e⁻ flows from the third magnetic layer 14 to the first magnetic layer 11.

At this time, the third magnetic layer 14 exhibits a spin filter effect, and an electron spin-polarized in the same direction as that of the magnetization of the third magnetic layer 14 is implanted in the second magnetic layer 12. That is, an electron spin-polarized in the opposite direction to that of the magnetization of the first magnetic layer 11 as a reference layer is implanted in the second magnetic layer 12.

This has the effect of shifting the hysteresis curve of the storage layer in the negative direction (left direction) in which the “1”-state easily arises. Thus, the hysteresis curve of the storage layer shifts in the negative direction by a shift H2. As a result, in the embodiment, the shift H_{shift} of the hysteresis curve equals H1+H2, and is smaller than in the comparative example.

Also, in the “1”-write, an electron spin-polarized in the opposite direction to that of the magnetization of the first magnetic layer 11 as a reference layer is reflected by the first magnetic layer 13 and is returned to the inside of the second magnetic layer 12 as in the comparative example.

In addition, an electron spin-polarized in the opposite direction to that of the magnetization of the first magnetic layer 11 imparts a spin torque to an electron in the second magnetic layer 12, whereby a magnetization reversal occurs in the second magnetic layer 12, and subsequently, a magnetization reversal occurs in the third magnetic layer 14.

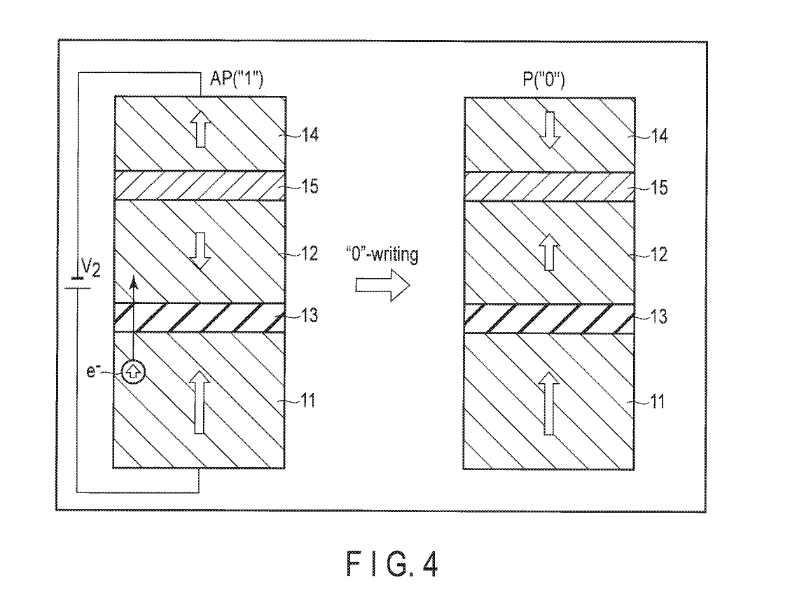

On the other hand, as shown in FIG. 4, when a positive potential V₂ is applied to the third magnetic layer 14 and a voltage of zero is applied to the first magnetic layer 11 in the “0”-write, a write current flows from the third magnetic layer 14 to the first magnetic layer 11. At this time, an electron e⁻ flows from the first magnetic layer 11 to the third magnetic layer 14.

At this time, an electron spin-polarized in the same direction as that of the magnetization of the first magnetic layer 11 is implanted in the second magnetic layer 12. That is, an electron spin-polarized in the same direction as that of the magnetization of the first magnetic layer 11 as a reference layer is implanted in the second magnetic layer 12. As a result, a magnetization reversal occurs in the second magnetic layer 12, and subsequently, a magnetization reversal occurs in the third magnetic layer 14.

However, this occurs in both the comparative example and the embodiment. That is, this does not have the effect of shifting, in the embodiment, the hysteresis curve of the storage layer in the positive direction (right direction) in which the “0”-state easily arises more than in the comparative example.

In addition, as shown in FIG. 3, in the embodiment, a stray magnetic field from the third magnetic layer 14 is applied to the second magnetic layer 12 in the “0”-state. The direction of a stray magnetic field from the third magnetic layer 14 is opposite to that of a stray magnetic field applied from the first magnetic layer 11 as a reference layer to the second magnetic layer 12. Thus the “1”-write is facilitated.

Therefore, as shown in the embodiment of FIG. 2, a line heading from “0” to “1” of the hysteresis curve shifts from a broken line (comparative example) to a solid line by a shift X1.

Similarly, as shown in FIG. 4, in the embodiment, a stray magnetic field from the third magnetic layer 14 is applied to the second magnetic layer 12 in the “1”-state. The direction of the stray magnetic field from the third magnetic layer 14 is the same as that of a stray magnetic field applied from the first magnetic layer 11 as a reference layer to the second magnetic layer 12. Thus the “0”-write is facilitated.

Therefore, as in the embodiment of FIG. 2, a line heading from “1” to “0” of the hysteresis curve shifts from a broken line (comparative example) to a solid line by a shift X0.

### Second Embodiment

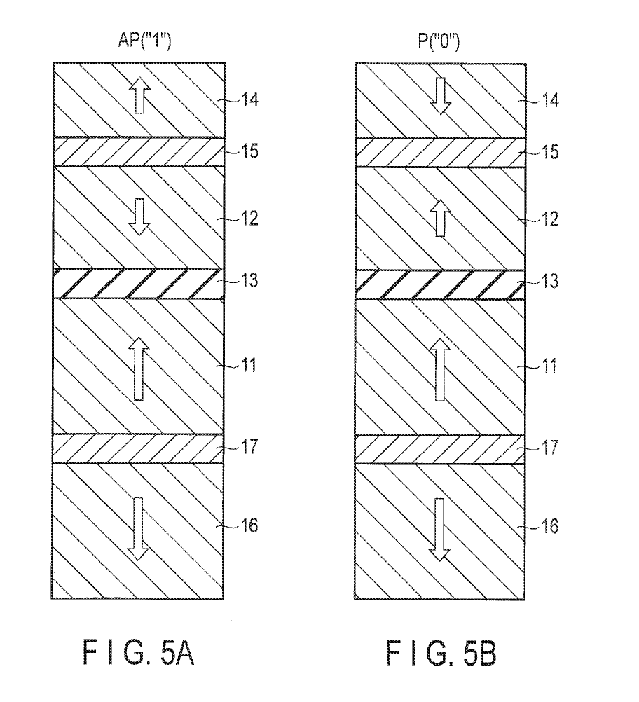

FIG. 5A and FIG. 5B show a magnetoresistive element according to a second embodiment.

This magnetoresistive element is a modification of the magnetoresistive element according to the first embodiment shown in FIG. 1A and FIG. 1B.

By the above-described structure of the first embodiment, a shift H_{shift} of the hysteresis curve of a storage layer of the magnetoresistive element is made small or cancelled. In this modification, an example of cancelling a residual shift H_{shift} by a shift canceling layer when a shift of the hysteresis curve remains a little even by the structure of the first embodiment will be described.

A fourth magnetic layer 16 is a shift canceling layer having invariable magnetization and has a magnetization direction opposite to that of a first magnetic layer 11 as a reference layer. Thus, a stray magnetic field applied from the first magnetic layer 11 as a reference layer to a second magnetic layer 12 as a storage layer can be cancelled by a stray magnetic field applied from the fourth magnetic layer 16 as a shift canceling layer to the second magnetic layer 12 as a storage layer.

The fourth magnetic layer 16 comprises, for example, a structure [Co/Pt]n in which a Co layer and a Pt layer are stacked in n layers.

A third nonmagnetic layer 17 is disposed between the first magnetic layer 11 and the fourth magnetic layer 16. The third nonmagnetic layer 17 functions as a magnetic coupling layer which makes the magnetization directions of the first and fourth magnetic layers 11 and 16 antiparallel to each other by a superexchange interaction.

The third nonmagnetic layer 17 comprises, for example, one of Ru, Ir, Rh, Cr, V, Mo, Re, and Os. The third nonmagnetic layer 17 has an appropriate material and thickness according to the materials of the first and fourth magnetic layers 11 and 16. The third nonmagnetic layer 17 preferably has a thickness in a range of 0.4 to 1.2 nm to magnetically couple the first magnetic layer 11 and the fourth magnetic layer 16.

The other elements are the same as in FIG. 1A and FIG. 1B. In FIG. 5A and FIG. 5B, the same elements as those of FIG. 1A and FIG. 1B are given the same numbers, and thus, a detailed explanation thereof is omitted.

### Application Example

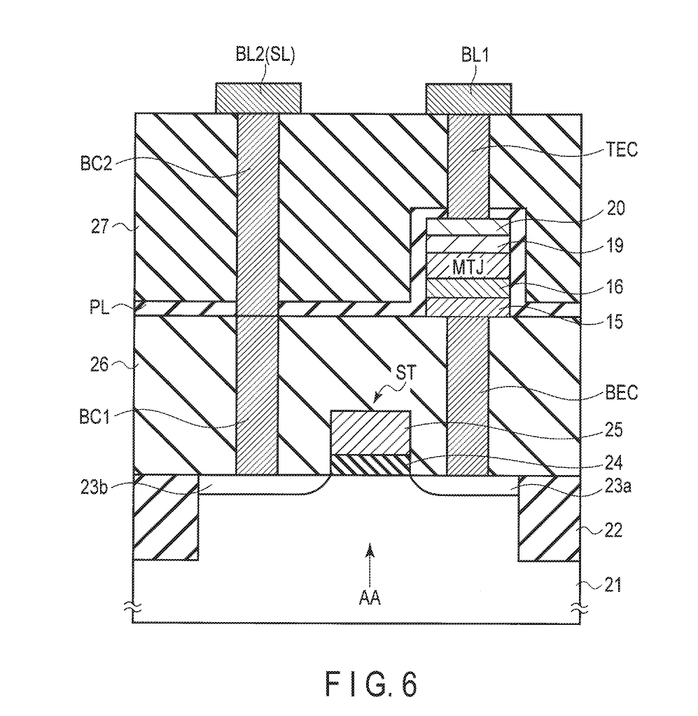

FIG. 6 shows a memory cell as an application example.

The memory cell of the present example is a memory cell of a magnetic random access memory comprising a magnetoresistive element according to the above-described first or second embodiment.

The memory cell comprises a select transistor (for example, an FET) ST and a magnetoresistive element MTJ.

The select transistor ST is disposed in an active area AA in a semiconductor substrate 21. The active area AA is surrounded by an element isolation insulating layer 22 in the semiconductor substrate 21. In the present example, the element isolation insulating layer 22 has a shallow trench isolation (STI) structure.

The select transistor ST comprises source/drain diffusion layers 23a and 23b in the semiconductor substrate 21, a gate insulating layer 24 on a channel between them, and a gate electrode 25 on the gate insulating layer 24. The gate electrode 25 functions as a word line.

An interlayer insulating layer (for example, a silicon oxide layer) 26 covers the select transistor ST. Contact plugs BEC and BC1 are disposed in the interlayer insulating layer 26. The top surface of the interlayer insulating layer 26 is flat. A lower-electrode 15 is disposed on the interlayer insulating layer 26.

The lower electrode 15 comprises, for example, one of Al, Be, Mg, Ca, Sr, Ba, Sc, Y, La, Sr, and Hf.

The lower electrode 15 is connected to the source/drain diffusion layer 23a of the select transistor ST via the contact plug BEC. The contact plug BC1 is connected to the source/drain diffusion layer 23b of the select transistor ST.

An underlying layer 16 is disposed on the lower electrode 15. The underlying layer 16 is provided to crystallize the magnetoresistive element MTJ. The underlying layer 16 preferably includes, for example, MgO, or a nitrogeneous compound of AlN, MgN, ZrN, NbN, SiN, AlTiN, etc.

The magnetoresistive element MTJ is disposed on the underlying layer 16. A cap layer 19 is disposed on the magnetoresistive element MTJ. The cap layer 19 functions as a buffer layer which prevents a reaction between the magnetoresistive element MTJ and an upper electrode 20. The cap layer 19 comprises, for example, Pt, W, Ta, or Ru.

The upper electrode 20 is disposed on the cap layer 19. The upper electrode 20 comprises, for example, W, Ta, Ru, Ti, TaN, or TiN.

A protective insulating layer (for example, a silicon nitride layer) PL covers a sidewall of the magnetoresistive element MTJ. An interlayer insulating layer (for example, a silicon oxide layer) 27 is disposed on the protective insulating layer PL, and covers the magnetoresistive element MTJ. The top surface of the interlayer insulating layer 27 is flat. Bit lines BL1 and BL2 are disposed on the interlayer insulating layer 27.

The bit line BL1 is connected to the upper electrode 20 via a contact plug TEC. The bit line BL2 is connected to the contact plug BC1 via a contact plug BC2.

The bit line BL2 is disposed on the source/drain diffusion layer 23b, and is connected to the source/drain diffusion layer 23b. The bit line BL 2 also functions as, for example, a source line SL connected to a sense amplifier, at the time of reading operation.

The bit lines BL1 and BL2 may be formed in interconnect layers differing from each other, or may be formed in the same interconnect layer.

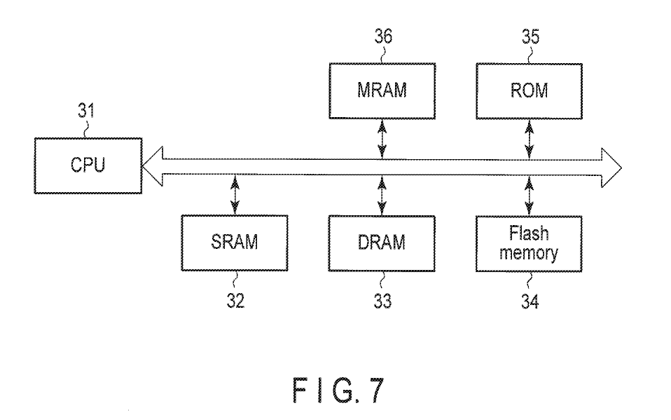

FIG. 7 shows a memory system as an application example.

This memory system is disposed, for example, in a processor.

A CPU 31 controls an SRAM 32, a DRAM 33, a flash memory 34, a ROM 35, and a magnetic random access memory (MRAM) 36.

The MRAM 36 comprises, for example, the memory cell of FIG. 6.

The MRAM 36 can be used as a replacement for any of the SRAM 32, the DRAM 33, the flash memory 34, and the ROM 35. Accordingly, at least one of the SRAM 32, the DRAM 33, the flash memory 34, and the ROM 35 can be omitted.

The MRAM 36 can be used as a nonvolatile cache (for example, an L2 cache).

### CONCLUSION

As described above, according to the present embodiments, a storage layer has an SAF structure, whereby a stray magnetic field applied from a reference layer to the storage layer can be cancelled.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetoresistive element comprising:
a first magnetic layer having an invariable magnetization direction;
a second magnetic layer having a variable magnetization direction;
a first nonmagnetic layer between the first and second magnetic layers;
a third magnetic layer having a variable magnetization direction, the magnetization directions of the second and third magnetic layers being opposite directions each other; and
a second nonmagnetic layer between the second and third magnetic layers.

2. The element of claim 1, wherein the second magnetic layer, the second nonmagnetic layer and the third magnetic layer have a synthetic antiferromagnetic structure.

3. The element of claim 1, wherein the magnetization directions of the first, second and third magnetic layers are a direction in which the first, second and third magnetic layers are stacked.

4. The element of claim 1, wherein the magnetization directions of the second and third magnetic layers are reversed in a state of being held antiparallel.

5. The element of claim 1, wherein a total magnetic moment of the third magnetic layer is less than or equal to a total magnetic moment of the second magnetic layer.

6. The element of claim 1, wherein the third magnetic layer is thinner than the second magnetic layer.

7. The element of claim 1, wherein the second magnetic layer includes CoFeB.

8. The element of claim 1, wherein the third magnetic layer includes one of FePt, CoPt, CoCr, TbCo, and SmCo.

9. The element of claim 1, wherein the second nonmagnetic layer includes one of Ru, Ir, Rh, Cr, V, Mo, Re, and Os.

10. The element of claim 1, wherein the second nonmagnetic layer has a thickness which is greater than or equal to 0.4 nm and is less than or equal to 1.2 nm.

11. The element of claim 1, further comprising a fourth magnetic layer having an invariable magnetization direction, the magnetization directions of the first and fourth magnetic layers being opposite directions each other.

12. A magnetoresistive element comprising:
a first magnetic layer having an invariable magnetization direction;
a second magnetic layer having a variable magnetization direction, the second magnetic layer including CoFeB;
a first nonmagnetic layer between the first and second magnetic layers;
a third magnetic layer having a variable magnetization direction, the third magnetic layer including one of FePt, CoPt, CoCr, TbCo and SmCo; and
a second nonmagnetic layer between the second and third magnetic layers, the second nonmagnetic layer including one of Ru, Ir, Rh, Cr, V, Mo, Re and Os.

13. The element of claim 12, wherein the magnetization directions of the second and third magnetic layers are opposite directions each other.

14. The element of claim 12, wherein the second magnetic layer, the second nonmagnetic layer and the third magnetic layer have a synthetic antiferromagnetic structure.

15. The element of claim 12, wherein the magnetization directions of the first, second and third magnetic layers are a direction in which the first, second and third magnetic layers are stacked.

16. The element of claim 12, wherein the magnetization directions of the second and third magnetic layers are reversed in a state of being held antiparallel.

17. The element of claim 12, wherein a total magnetic moment of the third magnetic layer is less than or equal to a total magnetic moment of the second magnetic layer.

18. The element of claim 12, wherein the third magnetic layer is thinner than the second magnetic layer.

19. The element of claim 12, wherein the second nonmagnetic layer has a thickness which is greater than or equal to 0.4 nm and is less than or equal to 1.2 nm.

20. The element of claim 12, further comprising a fourth magnetic layer having an invariable magnetization direction, the magnetization directions of the first and fourth magnetic layers being opposite directions each other.
